(19) United States
(12) Patent Application Publication
(10) Pub. No.: US 2004/0151564 A1
(43) Pub. Date: Aug. 5, 2004

(54) Crop transport system

(76) Inventor: Ronald P. Waguespack, Baton Rouge, LA (US)

Correspondence Address: Roy, Kiesel, Keegan and DeNicola, 2355 Drusilla Lane (70809), P. O. Box 15928, Baton Rouge, LA, 70895-5928, US

(21) Appl. No.: 10/356,219

(22) Filed: Jan. 31, 2003

(51) Int. Cl. B60P 1/04

(52) U.S. Cl. 414/491

(57) ABSTRACT

According to the present invention, the crop transport system is a trailer equipped with a hydraulic ram at one end used to pivot the end up for loading and unloading of a crop container, and further has a hydraulic system for keeping all of the wheels of the trailer in contact with the ground. Additionally, a unique system of guides is utilized to direct the loading and unloading of the crop container as well as the securing of the same in place aboard the trailer.

### BACKGROUND OF THE INVENTION

The present invention relates to loading and shipping of crops by using a trailer and basket system.

When transporting crops from the agricultural site to the processing facility, typically several trucks are employed for the task. Depending upon the site's volume, this may require a multitude of trucks, and moreover, a multitude of trailers. This need arises because often crops cannot be processed immediately, or as quickly as they are harvested. As such, crops must often spend some time waiting in or near the harvest site before they are processed.

This creates a problem in that some locations may or may not have storage bins or other facilities for storing these offloaded crops before they are weighed, treated and/or processed. As a result, these offloaded crops must be moved, sometimes multiple times, which is both time-consuming and inconvenient. Additionally, the crops in contact with the ground which can lead to insect infestation, rot and so forth.

This problem can be overcome, as it is now, by utilizing tractor-trailers which can leave detachable trailers at the harvesting location full of goods, and travel back and forth within the harvesting site, as well as from the site to the processing facility where another trailer is waiting. While using several trailers is certainly more cost-efficient than using an individual truck and trailer for each load, this has several economic disadvantages relative to the current invention.

Another currently-used approach is to leave the product in heaps at the harvest site, thus leaving the truck and trailer free to return to the processing facility to transport additional goods. This method is more economically advantageous in that it requires fewer trucks and/or trailers, but is disadvantageous in that the crops typically reside on the ground and in disorder, which can lead to insect infestation, rot, and the like, as previously mentioned.

The current invention fills the existing gap in technology by providing a crop trailer and basket system. This system permits the truck and trailer to be reused, while leaving the relatively less-expensive basket behind at the processing facility. By leaving the crop in the basket at the harvest site, the crop is not left in direct contact with the ground, preventing insect infestation, as well as keeping the product neat and organized. Additionally, the baskets permit the truck and trailer, which are the bulk of the cost of previous systems, to be towed back to the processing facility, drastically reducing the amount of equipment needed to transport crops.

It is known in the art to produce trucks which are capable of dumping product, as is known to load containers on and off of a trailer. The current devices in this field do not, however, offer the unique combination of trailer and basket in the configuration presented herein.

### OBJECTS OF THE INVENTION

One object of the invention is to provide a device capable of loading and unloading a crop container on a trailer utilizing a hydraulic assembly to pivot a trailer up and down.

Another object of this invention is to provide a trailer with a hydraulic assembly used to keep all rear wheels of a trailer in contact with the ground during loading and unloading.

Still another object of the invention is to provide a device which employs a wheeled system used to guide and secure a crop container on a trailer.

Other objects and advantages of this invention shall become apparent from the ensuing descriptions of the invention.

### SUMMARY OF THE INVENTION

According to the present invention, the crop transport system is a trailer equipped with a hydraulic ram at one end used to pivot the end up for loading and unloading of a crop container, and further has a hydraulic system for keeping all of the wheels of the trailer in contact with the ground. Additionally, a unique system of guides is utilized to direct the loading and unloading of the crop container as well as the securing of the same in place aboard the trailer.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 shows a side view of the trailer and container assembly in the down position.

FIG. 2 shows a side view of the trailer and container assembly in the up position.

FIG. 3 shows a side view of the hydraulic assembly of the axle stabilizer in the down position.

FIG. 4 shows a side view of the hydraulic assembly of the axle stabilizer in the up position.

FIG. 5 shows a side view of the trailer and container assembly loading a cargo container.

FIG. 6 shows a side view of the trailer and container assembly with a loaded cargo container.

FIG. 7 shows a cutaway view of the trailer chassis with the cargo container partly on the trailer.

FIG. 8 shows a cutaway top view of the trailer and container assembly locked in place.

FIG. 9 shows a rear view of the trailer illustrating the roller guides and guide rails.

FIG. 10 shows a front view of the trailer illustrating the guide rails.

FIG. 11 shows a detail view of the vertical guide system.

FIG. 12 shows a detail view of the winching system.

### DETAILED DESCRIPTION OF EXEMPLARY EMBODIMENTS

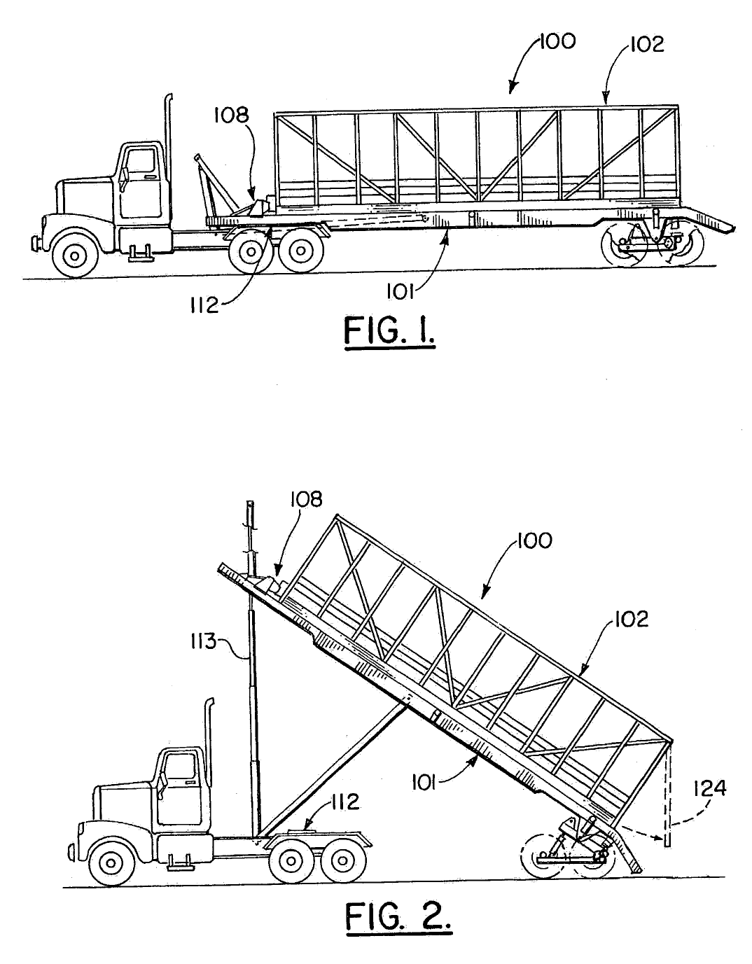

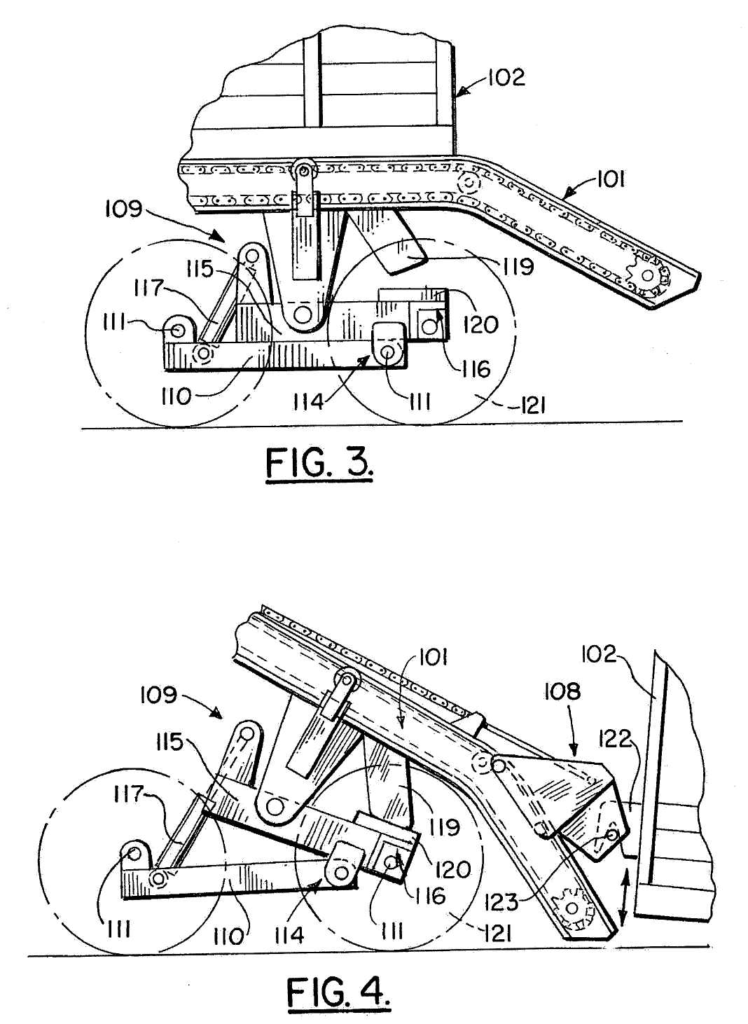

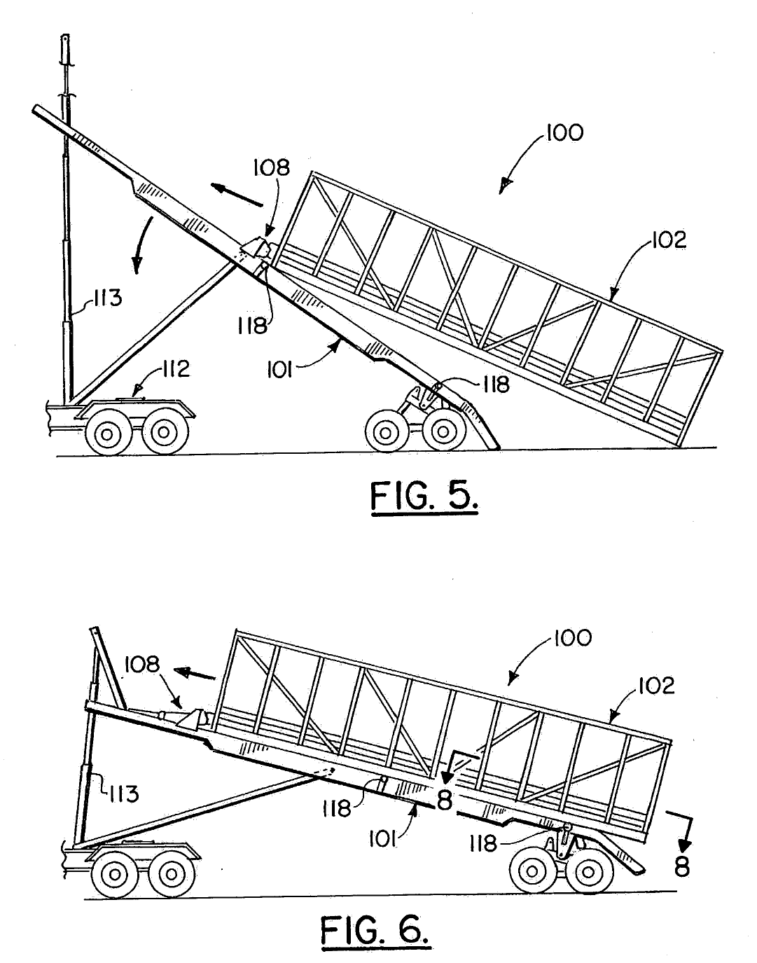

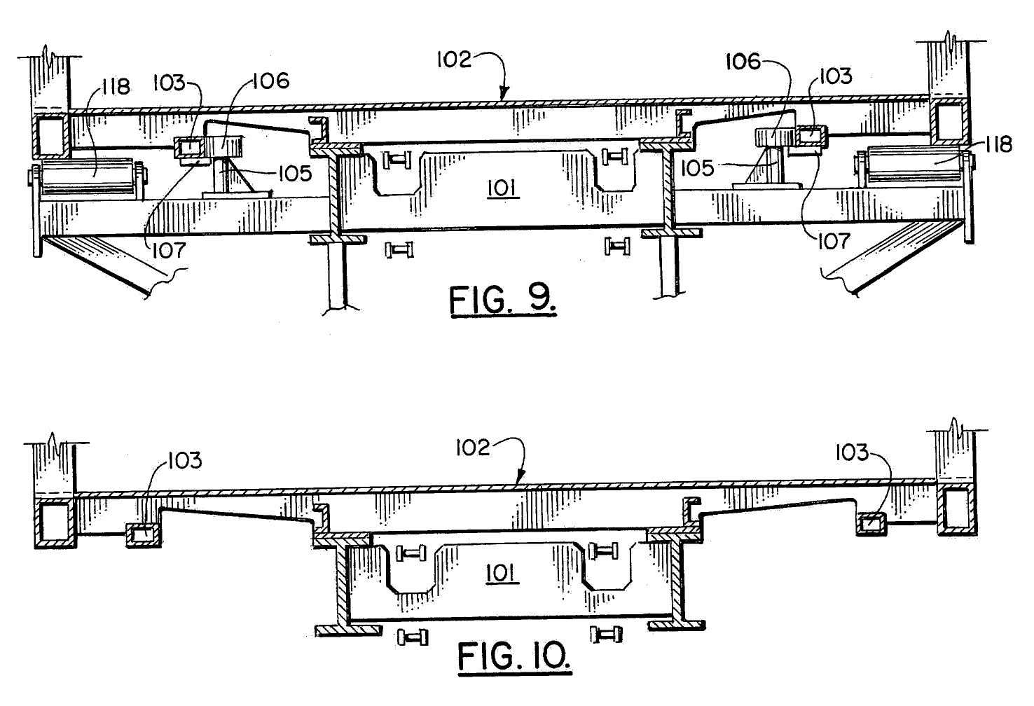

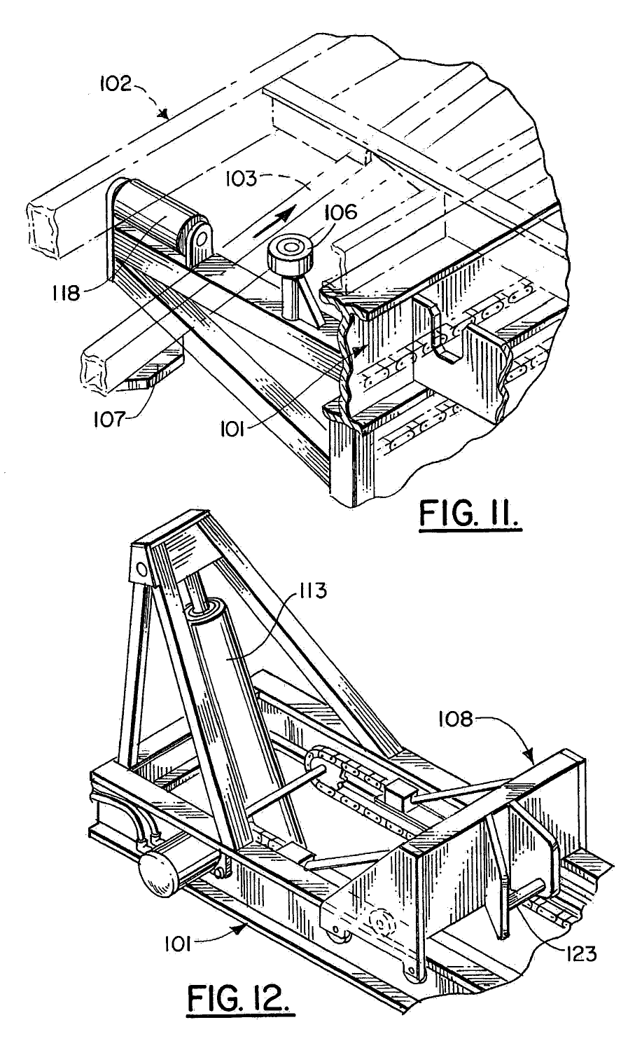

Without any intent to limit the scope of this invention, reference is made to the figures in describing the various embodiments of the invention. Referring to FIGS. 1 through 12, crop transport system 100 is pictured.

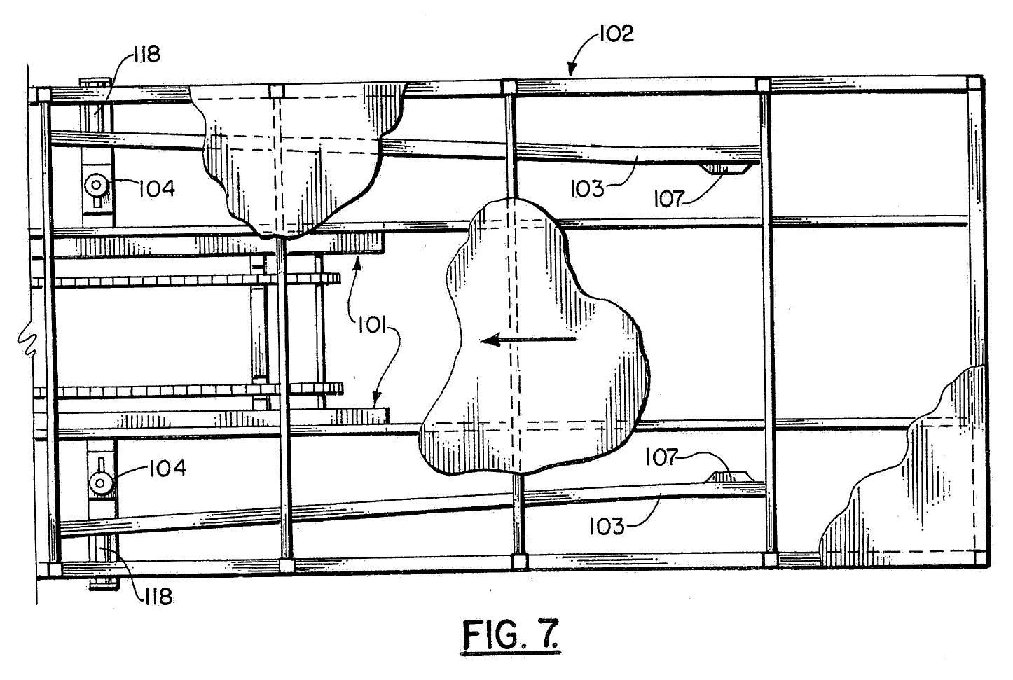

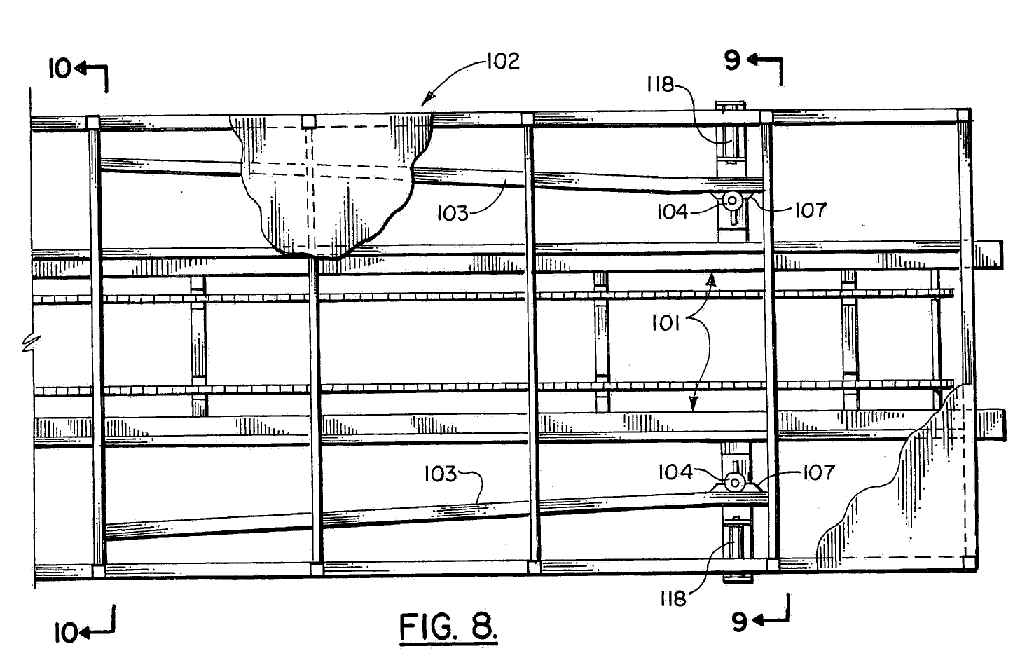

Crop transport system 100 can be a standalone vehicle, or it can be a tractor-trailer system as pictured in FIGS. 1 and 2. In one such tractor-trailer embodiment, trailer 101 will have as part of system 100 cargo container 102. Cargo container 102 can be substantially encased, with all sides enclosed except for the top, as in FIGS. 1 and 2. Other applications may require that cargo container 102 be completely closed in, as in FIGS. 7 and 8, when used in applications with light cargo, which may be carried off by wind gusts during transport, or those contents which may need to be secured to prevent theft or unauthorized tampering. In such an application, cargo container 102 may utilize a hinged lid or rear hatch 124, to permit the loading and unloading of the payload.

In order to integrate cargo container 102 with trailer 101, a series of rails 103 can be mounted to cargo container 102 from front to back, which are used to guide cargo container 102 onto trailer 101. These rails not only serve as a guiding system to load and unload cargo containers 102, but also limit the movement of cargo container 102 while loaded on trailer 101 by engaging some part or protrusion from cargo container 102 such as alignment pins or similar devices.

In another embodiment, a dual rail system may be employed, wherein matching rails can be mounted on trailer 101 which complement rails 103 mounted on cargo container 102. These matching rails add additional guiding forces and provide additional stability while loaded. It should be noted that other types of guide systems can be utilized in this or the previously-described system, such as guide cabling or the like, and such options are not limited to rails 103 disclosed herein.

Another element that can be used in these exemplary embodiments is that of a vertically mounted roller guide 104 mounted on trailer 101. Such an embodiment may include spindle 105 on which is mounted wheel 106 whose orientation is horizontal, or parallel to trailer's 101 bed.

As part of securing cargo container 102, rails 103 may employ a lip 107 which engages wheel 106 such that vertical motion of cargo container 102 is limited. In addition, wheel 106 and spindle 105 prevent horizontal motion as well, permitting motion only in a direction parallel to that of trailer's 101 bed. This parallel motion is controlled by winching system 108, which, when coupled with the above-referenced limits of motion, effectively locks cargo container 102 in place.

Another exemplary embodiment of cargo container 102 has rails 103 mounted on cargo container 102 where the distance between rails 103 increases, so that rails 103 are closer together at the end of cargo container 102 than they are at the front of cargo container 102. This achieves the result of requiring less precision when cargo container 102 is first loaded, and aligning cargo container 102 as it is loaded upon trailer 101.

Either alone, or in conjunction with the embodiments listed above, another improvement of trailer 101 of the crop transport system includes a stabilization system 109. Stabilization system 109 includes sub-chassis 110 which is affixed to trailer 101 on the underside of the rear end of trailer 101. Attached to sub-chassis 110 are axles 111 which provide the support and mobility required for trailer 101 to be moved, as is generally employed in a typical tractor-trailer arrangement.

At the forward end of trailer 101 are both hitching assembly 112 and extendible member 113, which can be hydraulic cylinder as pictured in FIGS. 1 and 2, or some other device capable of raising and lowering forward end of trailer 101. This motion by trailer 101 utilizes gravity to enable loading and unloading of cargo container 102.

In addition, trailer 101 includes winching assembly 108 which moves longitudinally along trailer 101. Winching assembly 108 is used to load and unload cargo container 102, which can be controlled via chains, cabling, or any other similar transporting device, by pulling cargo container 102 onto trailer 101. The connection is forged between cargo container 102 and trailer 101 via hook 122 and catch 123, the latter of which is a part of winching assembly 108.

Sub-chassis 110 is attached to the rear of trailer 101 by rotatable attachment 116, and can include small frame 115, attached to sub-chassis 110 and to trailer 101, utilizing a connection system such as a pin and socket at both attachments to trailer 101 and sub-chassis 110. This is such that sub-chassis can pivot along the rear. In combination with this, the front end of sub-chassis 110 is affixed to small frame 115 via second extendible member 117, which, again, can be a device such as extendible member 113.

Because of the double-hinged action of the sub-chassis 110 and small frame's 115 arrangement, stop 119 and stop plate 120 may be employed to prevent the rear cargo container 102 from abutting the rear wheels 121 of the trailer.

Horizontal rollers 118 can be employed at the end of trailer 101 to reduce friction as cargo container 102 is loaded thereon.

In operation, crop transport system 100 begins its cycle of use at the crop site. Once brought to the appropriate part of the site and positioned, extendible member 113 is extended, so that front end of trailer 101 is tilted upward. Once tilted, rear end of trailer 101 is near the ground. Winching assembly 108 is then gradually released, which in turn lowers cargo container 102 to ground below.

During this lifting procedure, second extendible member 117 can be extended such that sub-chassis 110 is forced downward, and thus its axles 111 are kept in contact with ground. This maintenance of contact with ground is what helps to keep trailer 101 level, and as a result, maintains stability. Also, stop 119 encounters stop plate 120 to prevent cargo container 102 from pivoting all the way rearward and contacting rear wheels 121.

During the unloading process, trailer 101 can be moved forward to facilitate unloading cargo container 102. Once cargo container 102 is substantially unloaded, hook and catch are released, which detaches cargo container 102 from winching assembly 108 and thus trailer 101, permitting cargo container 102 to be left behind.

Crop or other payload can be loaded into cargo container 102, where it can be stored until ready for processing. At such time, crop transport system 100 is dispatched to storage facility. If implemented, hinged or otherwise removable lid or rear hatch 124 will be closed and secured. Once at storage facility, crop transport system 100 is positioned on or near the location desired for cargo container 102 to be stored.

Loading is a similar process to unloading cargo container 102, but better illustrates more of the features contained in this invention. Cargo container 102 rests on ground, awaiting loading. Trailer 101 is backed up to cargo container 102 and extendible member 113 is extended in order to tilt trailer 101 upwards to prepare for loading. Simultaneously, second extendible member 117 may be extended to keep sub-chassis 110 and axles 111 in contact with ground below.

Once tilted upward, trailer 101 is in position for winching assembly's 108 catch 123 to engage hook 122 of cargo container 102. This engagement is achieved by backing up trailer 101 to cargo container 102, or otherwise placing cargo container 102 in relatively close proximity to trailer 101. Once engaged, winching assembly 108 is drawn toward the front of trailer 101 by motor or other mechanical device capable of pulling winching assembly 108 toward the front of trailer 101. As cargo container 102 is pulled upward, rails 103 on cargo container 102 will engage roller guides 104 which straighten cargo container 102 by virtue of the gradual decrease in spacing of rails 103. Simultaneously, if implemented, lip 107 of rails 103 will engage roller guides 104 such that lip 107 is restricted vertically by roller guides 104. This essentially “locks” cargo container 102 in place on trailer 101. In concert with this loading, extendible member 113 is retracted, lowering trailer 101, and, if utilized, second extendible member 117 is retracted as well, permitting sub-chassis 110 to return to its position tucked under trailer 101.

Once cargo container 102 is loaded on trailer 101, crop transport system 100 can be transported to the processing facility for dumping of the contents. Once brought to the appropriate part of the site and positioned, rear hatch 124 is opened to permit the extrication of goods from cargo container 102. Next, extendible member 113 is extended, so that front end of trailer 101 is tilted upward. Once tilted, rear end of trailer 101 is near the ground, and the contents of cargo container 102 will be released and unloaded so that crop transport system 100 may return to the harvesting site to obtain another full cargo container 102.

During this lifting procedure, second extendible member 117 will be extended such that sub-chassis 110 is forced downward, and thus its axles 111 are kept in contact with ground. This maintenance of contact with ground is what helps to keep trailer 101 level, and as a result, maintains stability. Also, stop 119 encounters stop plate 120 to prevent cargo container 102 from pivoting all the way rearward and contacting rear wheels 121.

This loading and unloading process enables the truck to return to the site where cargo is and pick up additional cargo containers 102. Effectively, then, this multitude of cargo containers 102 is just as efficient from a storage standpoint as many conventional trailers, but at a fraction of the cost and complexity, and thus is logistically superior.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A crop transport system comprising
a. a transport vehicle having a guide system; and
b. a cargo container, wherein said cargo container comprises
i. a floor, a left side, a right side, a front side and a rear side;
ii. a plurality of rails affixed to the outside of said floor of said cargo container and substantially parallel to the left and right sides;
iii. said rails configured to engage said guide system such that movement of said cargo container is substantially confined.

2. A crop transport system according to claim 1 wherein said guide system comprises a vertically mounted rotary device.

3. A crop transport system according to claim 2 wherein said rails further comprise a lip capable of maintaining a locked relationship with said vertically mounted rotary device such that vertical motion is limited.

4. A crop transport system according to claim 3 wherein said rails further comprise a lip capable of maintaining a locked relationship with said vertically mounted rotary device such that horizontal motion is limited.

5. A crop transport system according to claim 1 wherein said rails are affixed such that they are in closer proximity to each other near said front side, and further apart near said rear side.

6. A crop transport system comprising
a. a cargo container; and
b. a transport vehicle comprising
i. a chassis and forming a generally horizontal surface, said chassis having a first face, a second face, a front end and a rear end;
ii. a sub-chassis affixed to said chassis on said second face near said rear end of said chassis;
iii. at least two axles affixed to said sub-chassis;
iv. said chassis being able to pivot said front end upwards using a first extendible member such that said rear end is brought closer to the surface beneath said chassis;
v. a second extendible member affixed to said chassis and to said sub-chassis such that said sub-chassis is urged downward when said chassis is pivoted upward, said axles thus keeping mechanical communication with said surface beneath said chassis.

7. A crop transport system according to claim 6 wherein said first extendible member is a hydraulic shaft.

8. A crop transport system according to claim 7 wherein said second extendible member is a hydraulic shaft.

9. A crop transport system according to claim 6 wherein said second extendible member is a hydraulic shaft.

10. A crop transport system according to claim 6 further comprising a hitching system affixed substantially near said front end of said chassis.

11. A crop transport system comprising
a. a transport vehicle comprising
i. a chassis forming a generally horizontal surface, said chassis having a first face, a second face, a front end and a rear end;
ii. a sub-chassis affixed to said chassis on said second face near said rear end of said chassis;
iii. at least two axles affixed to said sub-chassis;
iv. said chassis being able to pivot said front end upwards using a first extendible member such that said rear end is brought closer to the surface beneath said chassis;
v. a second extendible member affixed to said chassis and to said sub-chassis such that said sub-chassis is urged downward when said chassis is pivoted upward, said axles thus keeping mechanical communication with said surface beneath said chassis; and
vi. a guide system; and
b. a cargo container comprising
i. a floor;
ii. a left side;
iii. a right side;
iv. a front side;
v. a rear side;
vi. a plurality of rails affixed to the outside of said floor of said cargo container and substantially parallel to the left and right sides, wherein said rails are affixed such that they are in closer proximity to each other near said front side, and further apart near said rear side, and wherein said rails are configured to engage said guide system such that movement of said cargo container is substantially confined.
